(19) United States
(12) Patent Application Publication
(10) Pub. No.: US 2005/0101334 A1
(43) Pub. Date: May 12, 2005

(54) System and method for incident reporting, information gathering, reconstructing and alerting

(76) Inventors: Daniel P. Brown, Palatine, IL (US); Senaka Balasuriya, Arlington Heights, IL (US); Stephen N. Levine, Itaska, IL (US); Nitya Narasimhan, Schaumburg, IL (US); Marcia J. Otting, Mundelein, IL (US)

Correspondence Address: MOTOROLA INC, 600 NORTH US HIGHWAY 45, ROOM AS437, LIBERTYVILLE, IL, 60048-5343, US

(21) Appl. No.: 10/692,634

(22) Filed: Oct. 24, 2003

(51) Int. Cl. H04Q 7/20

(52) U.S. Cl. 455/456.3

(57) ABSTRACT

A system and method for processing information about an incident is provided. The system comprises two or more communication devices (104, 112-126) in communication with each other and a central authority (128) capable of receiving data from the communication devices. Each communication device (104, 112-126) includes a media sensor (222) to collect data relating to an incident event (102). One communication device (104), in response to a user activation input, transmits a request signal to one or more other communication devices (112-126). Any communication device (112-126) that receives the request signal may collect data relating to the incident event (102) in response to the request signal. The central authority (128), after receiving the data collected by the wireless communication devices (104, 112-126), performs an action in response to receiving the data.

### FIELD OF THE INVENTION

The present invention relates generally to the field of wireless communication devices having media sensor, such as cameras and microphones. In particular, the present invention relates to wireless communication devices that are capable of collecting media information, i.e., images, video and/or audio, about an incident so that data collected about the incident may be utilized at a later date and/or time.

### BACKGROUND OF THE INVENTION

A camera phone, i.e., a cellular phone having a camera attachment or built-in camera, provides a unique opportunity for its user. In particular, the combination of a camera and a wireless transceiver provides the user the ability to capture images and send the images to other cellular phones. Accordingly, users of camera phones have a communication advantage over users of cellular phones without cameras. If a law enforcement officer has a cellular phone capable of receiving and viewing such images, the camera phone user may send images relating to a crime incident to the law enforcement officer.

A wireless device user at an incident, such as a crime incident, may not have the ability to capture all views as desired. For example, the user may not be situated at an optimal position relative to the incident and/or may not have the time to capture the images as he or she desires, particularly if the user is running to or from the incident. In fact, other device users in the vicinity of the incident may have opportunities to capture better views of the incident. Unfortunately, an efficient means for coordinating data capture from multiple users is not available.

There is a need for a system and method that collects data about an incident from an ad hoc collection of mobile devices. There is also a need for privacy safeguards for those devices that share information about the incident, such as location or other revealing information. For example, if an incident occurs at or near a user of a wireless communication device, the user may attempt to capture data relating to the incident and send the data to an incident reporting center using the device. The user would desire other devices in the vicinity to capture data relating the incident as well. However, it would be difficult for the user to identify and contact other devices in the vicinity, let alone devices having camera and communication capabilities. Even if the user could contact such devices, the users of such devices may be reluctant to share information with the originating user.

There is a further need for a system and method that reconstructs an incident based on data collected from the ad hoc collection of mobile devices and/or alerting users of other mobile devices of the situation caused by the incident. For example, it is desirable to alert other device users in the area or path of the incident regarding the possibility of involvement.

### BRIEF DESCRIPTION OF THE DRAWINGS

FIG. 1 is a diagrammatic view of various devices associated with a given incident in accordance with the present invention.

FIG. 2 is a block diagram representing exemplary components of each device of the embodiment of FIG. 1.

FIG. 3 is a flow diagram of an operation of an first reporting device in accordance with the present invention.

FIG. 4 is a flow diagram of a procedure that may be called by the operation of FIG. 3.

FIG. 5 is a flow diagram of an operation of a second reporting device in accordance with the present invention.

FIG. 6 is a flow diagram of a procedure that may be called by the operation of FIG. 5.

FIG. 7 is a flow diagram of an operation of a proximity server in accordance with the present invention.

FIG. 8 is a flow diagram of an operation of a central authority in accordance with the present invention.

FIG. 9 is a perspective view of an exemplary incident that may utilize the present invention.

### DETAILED DESCRIPTION OF THE PREFERRED EMBODIMENTS

The present invention uses multiple wireless communication devices to send information about an incident to an incident reporting center. A short-range transmission media, preferably a wireless local area network protocol, is used to create an ad-hoc network of wireless communication devices for the purpose of reporting data pertaining to an incident. The second reporting device may thus cause multiple devices to report the incident either to the controlling device for relayed transmission to the incident reporting center, or cause other devices to contact the incident reporting center directly. A command message from a single device is used to control the recording mechanisms of other, nearby devices.

The present invention may also have other capabilities for enhanced operation. A command message from a disabled wireless device may be used to enable another nearby device to become the focal point of the incident reporting process. Multiple media streams, as received at an incident reporting center, may be used to reconstruct the incident for analysis and for identification of one or more individuals. When an incident has been analyzed, an alert with applicable media information may be sent to other wireless users in the vicinity or in vicinities that are likely to be affected. Selection of target devices for the alert can be determined in a variety of ways, such as via a location service.

One aspect is a method for a wireless communication device, such as an first reporting device, to provide information about an incident. The device detects an activation input of an incident event. The device then scans for one or more remote devices and coordinates collection of data with the one or more remote devices. Next, the device records data relating to the subject matter of the incident event. Thereafter, the device transmits the recorded data to a designated location.

Another aspect is a method for a wireless communication device, such as a second reporting device, to provide information about an incident. The device detects a request signal of an incident event from a remote device. The device then receives information from the remote device about a designated location. Next, the device records data relating to the subject matter of the incident event. Thereafter, the device transmits the recorded data to the designated location.

Still another aspect is a method of a central authority for receiving information about an incident from one or more remote devices. The central authority receives incident information about an incident event from a remote device. The central authority then compares the incident information to previously received information to identify all or part of the previously received information that relates to the incident information. The previously received information, or the part that relates to the incident information, includes information received from a device other than the remote device. Thereafter, the central authority correlates the incident information with all or part of the previously received information that relates to the incident information.

Yet another aspect is a system for processing information about an incident comprising a first wireless communication device, a second wireless communication device and a central authority configured to receive data collected by the first and second wireless communication devices relating to an incident. The first wireless communication device includes a first short-range transceiver to transmit a request signal and a first media sensor to collect data relating to the incident event in response to a user activation input. The second wireless communication device includes a second short-range transceiver to receive the request signal and a second media sensor to collect data relating to the incident event in response to the request signal. The central authority performs an action in response to receiving the data.

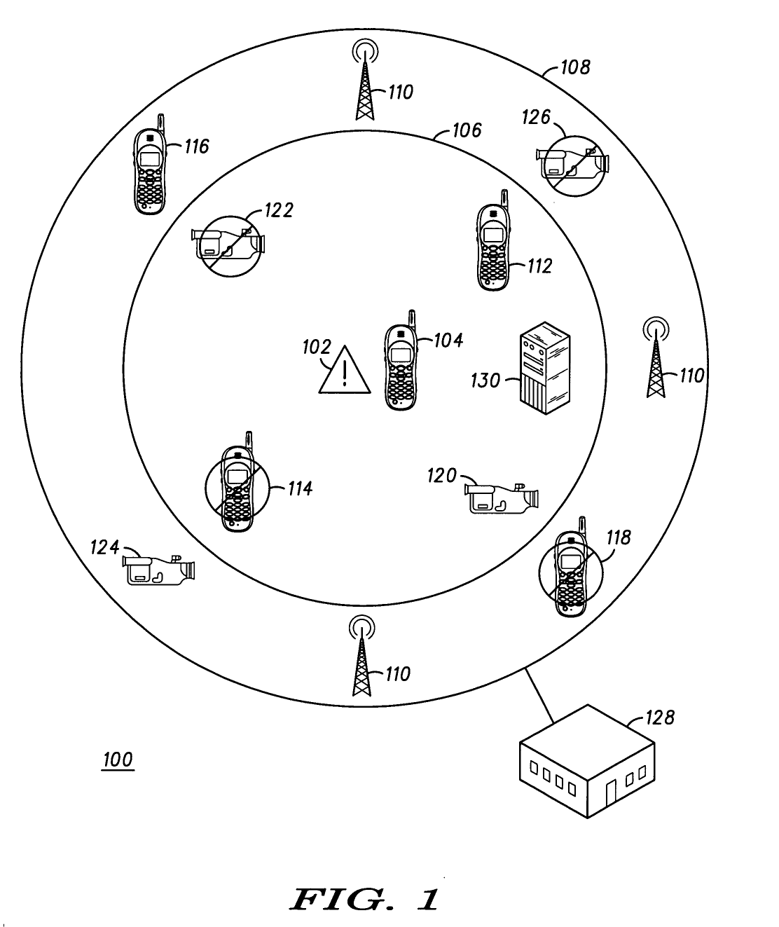

Referring to FIG. 1, there is provided a system 100 of various devices associated with a given incident. Central to the diagram is an incident 102 and an first reporting device 104 located at or near the incident. When the first reporting device 104 notices the incident 102, the first reporting device scans for other wireless communication devices within the vicinity of the incident and the first reporting device. For example, the first reporting device 104 may include and utilize a short-range transceiver to identify all wireless communication devices that are within communication range 106 of the first reporting device. Examples of the protocol used by short-range transceivers include, but are not limited to, Bluetooth, IEEE 802.11 (such as 802.11a, 802.11b and 802.11g), and other types of WLAN protocols. Also, the first reporting device 104 may include and utilize a longer-range transceiver to receive information about devices within the vicinity 108 of the incident and/or first reporting device. Examples of the protocol used by longer-range transceivers include, but are not limited to cellular-based protocols, such as Analog, CDMA, TDMA, GSM, UMTS, WCDMA and their variants. A positioning system may be used by the wireless communication devices to provide location information to the first reporting device 104 or to determine whether a particular device is in the vicinity 108. Examples of positioning systems include, but are not limited to, a Global Positioning System (“GPS”) and a wireless signal triangulation system by base stations 110.

The first reporting device 102 and the other wireless communication devices include at least one wireless transceiver and at least one sensor. Some wireless communication devices may be mobile devices 112, 114, 116 & 118, whereas other wireless communication devices may be stationary or fixed devices 120, 122, 124 & 126, such as surveillance cameras mounted to poles. Mobile devices include, but are not limited to, radio phones (including cellular phones), portable computers with wireless capabilities, wireless personal digital assistants, pagers, and the like.

It is important to note that not all wireless communication devices within communication range 106 or within the vicinity 108 may be able to provide data relevant to the incident 102. For example, certain devices may not have a line of sight to the incident, may not be within audible distance, and/or may not have a sensor to capture data. In FIG. 1, wireless communication devices 114, 118, 122 and 126 are marked to represent devices that cannot provide relevant information.

The data collected from the first reporting device 104 and the remaining wireless communication devices 112, 116, 120 & 124 is communicated to an incident reporting center 128. The data may be gathered by the first reporting device 104 and communicated to the incident reporting center 128, gathered by a local server 130 and communicated to the incident reporting center, sent directly to the incident reporting center by each individual device, or a combination thereof. The data may be communicated to the incident reporting center 128 by any communication media available between the device or devices and the incident reporting center, such as short-range wireless communication, longer-range wireless communication or landline communication.

During operation, the first reporting device 104 transmits or broadcasts a request signal to each available wireless communication device, such as devices 112, 116, 120 & 124. Each of the available wireless communication devices will collect data relating to the incident event in response to receiving the request signal. Subsequently, the incident reporting center 128, i.e., central authority, receives the data collected by the first reporting device 104 and the available wireless communication devices, such as device 112, 116, 120 & 124, relating to the incident event and performs an action in response to receiving the data.

Wireless communication devices may have the ability to capture single or multiple images. Examples of capturing multiple images include recording a continuous stream of images of an action event such as a crime, sports play, concert or other type of incident. In a multimedia application, the wireless communication devices might also capture and store high-quality audio and text/time-date, etc. Data captured by the wireless communication devices may be limited by each device's storage capacity, so a particular device may only record a fixed duration of a continuous image scene. Further, the wireless communication devices may capture and record a “continuous loop” of data by deleting/overwriting data as new data is captured, or deleting/overwriting an entire segment of data when the segment is full.

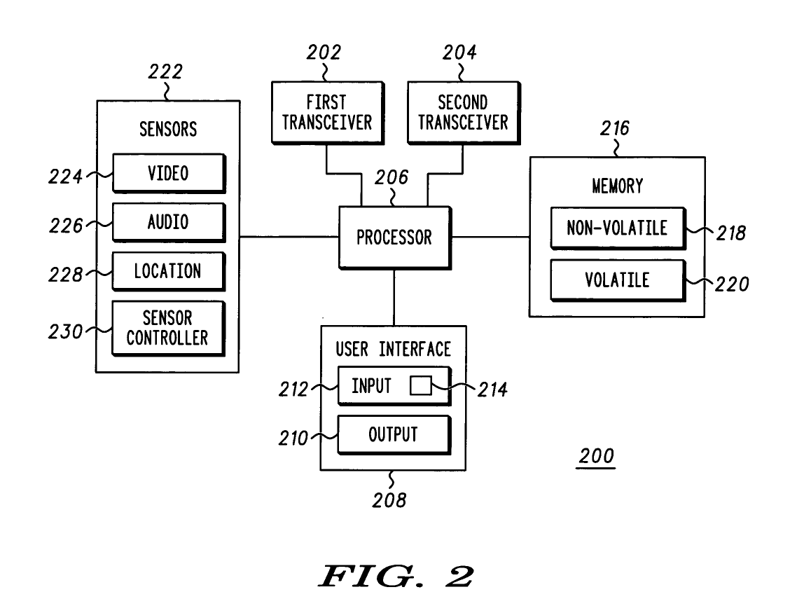

Referring to FIG. 2, there is provided a block diagram representing exemplary internal components 200 of each device, such as the first reporting device 104, the other devices 110-126, the local server 130, and the remote server at the incident reporting center 128 shown in FIG. 1. The exemplary embodiment includes one or more transceivers 202, 204; a processor 206; and a user interface 208 that includes output devices 210 and input devices 212. The input devices 212 of the user interface include an activation switch 214.

Each device must have at least one communication transceiver to communication with the other devices of the system 100. The first reporting device 104 must have a short-range transceiver 202 for communication with other wireless communication devices. The first reporting device 104 may also include a longer-range transceiver for direct communication to the incident reporting center 128 or may utilize the short-range transceiver for indirect communication to the incident reporting center via another wireless communication device or the local server 130. Similar to the first reporting device 104, other wireless communication device must have a short-range transceiver 202 but may or may not have a longer-range transceiver. The local server 130 must have a short-range transceiver 202 for communication with the first reporting device 104 and the other wireless communication devices as well as a second transceiver 204 for communication with the incident reporting center 128. For the local server, the second transceiver 204 has longer-range communication capabilities than the short-range transceiver 202. For example, the second transceiver 204 may communication via longer-range communication media or wireline link (e.g. PSTN connection). The incident reporting center 128 may have any type of communication media for communication with the wireless communication device and the local server 130, such as a longer-range transceiver or wireline link.

To further clarify the functions of the wireless device as represented by the internal components 200, upon reception of wireless signals, the internal components detect communication signals and a transceiver 202, 204 demodulates the communication signals to recover incoming information, such as voice and/or data, transmitted by the wireless signals. After receiving the incoming information from the transceiver 202, 204, the processor 206 formats the incoming information for output to the output devices 210. Likewise, for transmission of wireless signals, the processor 206 formats outgoing information and conveys it to the transceiver 202, 204 for modulation to communication signals. The transceiver 204 conveys the modulated signals to a remote transceiver (not shown).

The input and output devices 210, 212 of the user interface 208 may include a variety of visual, audio and/or motion devices. The output devices 210 may include, but are not limited to, visual outputs (such as liquid crystal displays and light emitting diode indicators), audio outputs (such as speakers, alarms and buzzers), and motion outputs (such as vibrating mechanisms). The input devices 212 may include, but are not limited to, mechanical inputs (such as keyboards, keypads, selection buttons, touch pads, capacitive sensors, motion sensors, and switches), and audio inputs (such as microphones). The input devices 212 includes an activation switch 214 that may be activated by a user when a user desires initiating of the incident reporting function, as well as any other function, in accordance with the present invention.

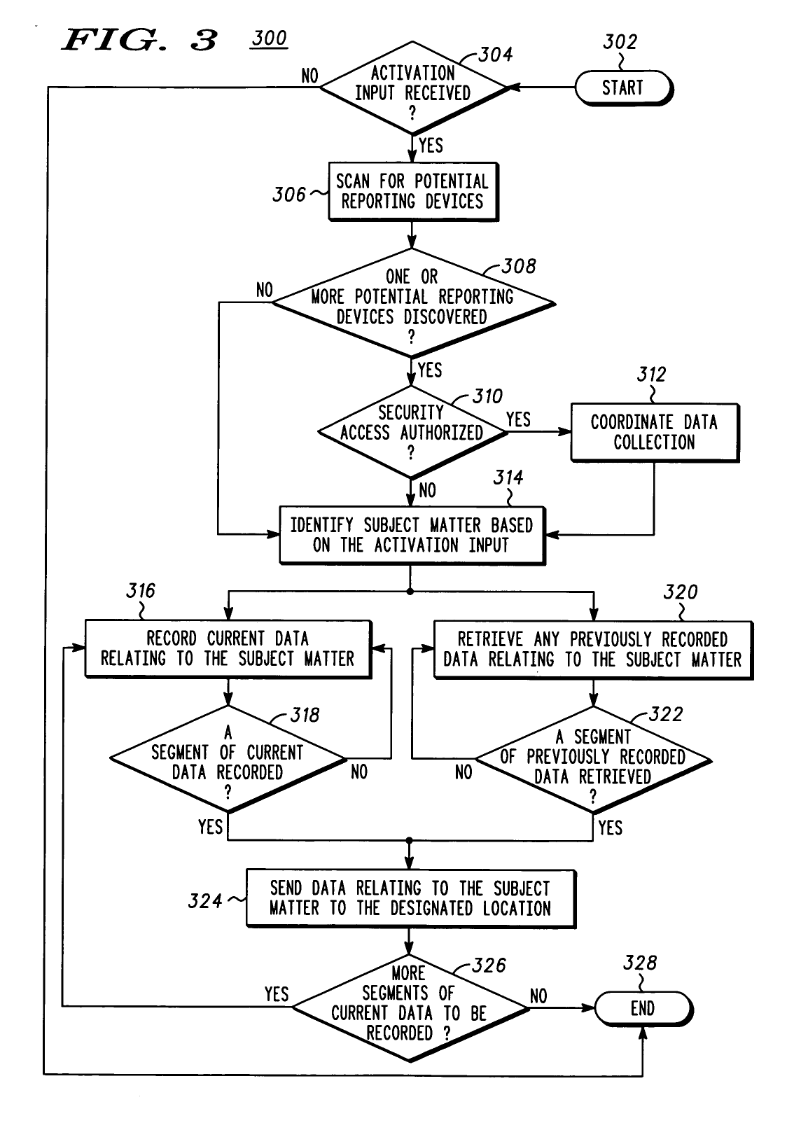

The internal components 200 of the device further include a memory portion 216 for storing and retrieving data. The memory portion 216 includes a non-volatile memory portion 218 and a volatile memory portion 220. The non-volatile memory portion 218 may be used to store operating systems, applications, communication data and media data. The applications include, but are not limited to, the applications described below in reference to FIGS. 3 through 8 for operating a device. The communication data includes any information that may be necessary for communication with other devices, communication networks and wireline devices. The media data includes any information that may be collected by sensors of the device, such as those sensors described below. The volatile memory portion 220 of the memory portion 220 provides a working area for processing data, such as digital signal processing of the data collected by the sensors. The processor 206 may perform various operations to store, manipulate and retrieve information in the memory portion 216. The processor 206 is not limited to a single component but represents functions that may be performed by a single component or multiple cooperative components, such as a central processing unit operating in conjunction with a digital signal processor and an input/output processor.

The internal components 200 of the device may further include one or more sensors 222. For example, as shown in FIG. 2, the sensors 222 include a video sensor 224, an audio sensor 226 and a location sensor 228. Each sensor 224, 226, 228 may have its own sensor controller for operating the sensor, or a general sensor controller 230 may be used to operating all sensors. The video sensor 224 may collect still images, continuous video or both. The audio sensor 226 may be directed to collect certain types of sounds, such as voice, or all sounds received. The location sensor 228 may be used to determine the position of the device and, thus, a GPS receiver is an example of a location sensor. It is to be understood that a single component of the device may operate as a component of the user interface 208 and a component of the sensors 222. For example, a microphone may be a user interface 208 to receive audio voice information for a phone call as well as a sensor 222 to receive ambient sounds for incident data collection.

At this point, an example for utilizing the internal components 200 may be helpful for understanding the interaction among these components. For example, the internal components 200 may comply with E-911 regulations, and a user may initiate an emergency call by activating the activation switch 214 of the user interface 208. The trigger of the activation switch 214 may be activation of a “panic button”, detection of a high stress level of the user, detection of motion by a physical shock detector, or the occurrence of bright flashes or loud ambient noises. In response to receiving an activation signal from the activation switch 214, the processor 206 would then upload multimedia data from the incident scene. In particular, the processor would instruct one or more sensors 224, 226, 228 and/or the sensor controller 230 to collect data and store the collected data in the non-volatile memory portion 218 of the memory portion 216. The sensors 222 may provide the collected data to the memory portion 216 directly or through the processor 206. The processor 206 may also gather data previously provided to the memory portion 216 by the sensors 222. In addition to finding data collected by its own sensors 222, the processor 206 may also find data collected by sensors of other wireless communication devices by sending a request signal via a transceiver 202, 204. The processor 206 may also utilize a transceiver 202, 204 to transmit collected data to a designated location or destination, such as the incident reporting center 128.

To protect against malicious misuse, the processor 206 may utilize certified public key methods and store security-related data or “keys” in the memory portion 216, preferably the non-volatile memory portion 218. The use of certificates may provide addition features for each device, such as dictating that any upload, once permitted, may be sent to a single destination of the user's choice. For example, a user may predetermine that all visual and audio records may only be sent to the Federal Bureau of Investigation (“FBI”). Subsequently, if the user permits an upload of certain records, the FBI would be the sole destination for these records.

Referring to FIG. 3, there is provided a flow diagram of an incident reporting procedure 300 of the first reporting device 104. The first reporting device 104, i.e., the triggering or initiating device, has a short-range communication means, such as Wi-Fi or Bluetooth, to communicate with other wireless communication devices within communication range and/or in the vicinity. Upon determination that an incident 102 needs to be reported, the first reporting device 104 sends a short-range inquiry or request signal requesting that other devices respond. Each of the other devices, upon receipt of this request signal, will send a response that contains its identity (“ID”) to the first reporting device 104. Upon receiving one or more responses, the first reporting device 104 will be able to identify the potential second reporting devices.

The incident reporting procedure 300 shown in FIG. 3 is an exemplary operation that may be executed by the processor 206, stored in the memory portion 216, and provide interaction for the other internal components of the first reporting device 104. Starting at step 302, the incident reporting procedure 300 of the first reporting device 104 first determines whether an activation input has been received at step 304. For example, an activation input may be a key selection at the user interface 208 of the first reporting device 104. If an activation input has not been received, then the incident reporting procedure 300 terminates at step 328. On the other hand, if the activation input is received, then the processor 206 utilizes a transceiver 202 or 204 to scan for potential second reporting devices at step 306. In a short-range communication environment, it is expected that there will be a high correlation between signal strength and distance. In one embodiment, the first reporting device 104 may measure signal strengths of received responses and identify those nearby devices having the highest signal strengths, thus having the highest likelihood of providing data relating to the incident 102.

In another embodiment, the request signal, at step 306, may request that all receiving wireless communication device “freeze” their camera feeds for a particular time period to prevent incident-related information from being over-written. In yet another embodiment, the information gathered from nearby devices at step 306 may include whether they are camera-enabled. A camera-enabled device may provide video or multimedia feed to the first reporting device 104 and/or the incident reporting center 128. If a nearby device is not camera-enabled, it may have an audio feed to offer. The first reporting device 104 or the incident reporting center 128 may request the audio information, but label it as having a lower priority. Lower priority information may, for example, be placed towards the end of a reporting queue. For a further embodiment, all second reporting devices may report battery charge status at step 306 to further assist the incident reporting function to raise its priority in the reporting queue so that information is not lost due to a state of low battery charge.

If the processor 206 discovers one or more potential second reporting devices at step 308, then the processor will attempt to obtain security access authorization, for example, by utilizing certified public key methods, from each potential second reporting device at step 310. If the processor 206 is successful in obtaining the security access authorization, then the processor coordinates data collected by the first reporting device 104 with data collected by each second reporting device at step 312. At minimum, the processor 206 associates the data collected from the various sources so that a data gathering or reconstruction device or facility may understand that all of the data relates to a similar incident. If the processor 206 does not discover any potential second reporting devices, does not receive security access authorization or performs the steps necessary to coordinate data collection, then the processor moves on to identify the subject matter of the incident 102 at step 314.

In one embodiment, the subject matter may be identified based on the activation input. For example, the user of the first reporting device 104 may point the video sensor 224 and/or audio sensor 226 at the incident 102 so that activation at the user interface 208 may capture the incident as a still image, video stream, discrete sound, audio stream or a multimedia combination thereof.

Once the subject matter of the incident 102 is identified, the processor 206 records current data relating to the subject matter and/or retrieves any previously recorded data relating to the subject matter. The current data and the previously recorded data may be obtained serially or, as shown in FIG. 3, obtained in parallel. The processor 206 may obtain current data from the sensors 222 at step 316. The processor 206 continues to record the current data until a predetermined time period or file size has been recorded, as determined by step 318. Similarly, the processor 206 may obtain previously recorded data from the memory portion 216 at step 320. The processor 206 continues to retrieve the previously recorded data until a predetermined time period or file size has been retrieved, as determined by step 322.

After the current data is recorded, the previously recorded data is retrieved or both, the processor 206 may send the data to a designated location at step 324. The designated location may be a wireless communication device (such as any one of devices 112 through 126) or the local server 130 that forwards the data to the incident reporting center 128 or the designated location may be the incident reporting center itself. If more data relating to the incident 102 is available from the sensors 222 or is required by the incident reporting center 128, then the processor 206 may continue to record more current data at step 326 and repeat steps 316, 318 and 324. For example, the processor 206 may continue to record current data until the user interface 208 of the first reporting device 104 or the incident reporting center 128 via transceiver 202 or 204 informs the processor that data is no longer available or needed. Finally, the incident reporting procedure 300 terminates at step 328.

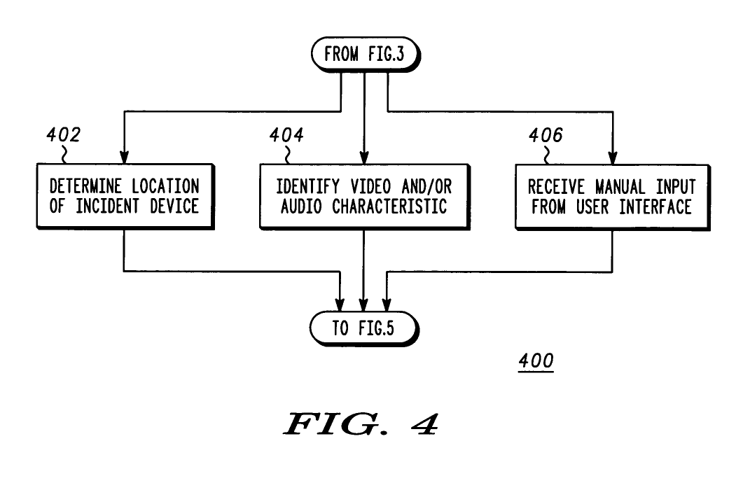

Referring to FIG. 4, there is provided possible operational details of coordination of data collection of the incident 102 at step 312 of FIG. 3. The processor 206 may perform one or more of these steps to identify the subject matter of the incident 102. For one embodiment, the processor 206 may determine the location of the first reporting device using a location sensor 228 at step 402. For example, the processor 206 may determine a location of the first reporting device 104 and, being near the incident 102, the location of the first reporting device may serve at the location of the incident. The calculated location of the incident 102 is provided to other wireless communication devices via transceiver 202 or 204. To further enhance the determination of the incident location, the processor 206 may receive data from the sensors 222 to determine the distance and direction of the incident relative to the first reporting device 104. Based on this differential from the first reporting device 104, the processor 206 may more accurately determine the location of the incident 102. The enhanced location of the incident 102 is provided to other wireless communication devices via transceiver 202 or 204.

For another embodiment, the processor 206 may use data received from the sensors 222. As described above in reference to step 314, the user of the first reporting device 104 may point the video sensor 224 and/or audio sensor 226 at the incident 102 so that activation at the user interface 208 may capture the incident as a still image, video stream, discrete sound, audio stream or a multimedia combination thereof. Through image and/or sound processing techniques, the processor 206 may identify distinct characteristics of the incident 102 at step 404, such as rapidly moving objects, high decibel sounds and shapes that match predetermined patterns stored in the memory portion 216. The video and/or audio characteristics of the incident 102 are provided to other wireless communication devices via transceiver 202 or 204.

For yet another embodiment, the processor 206 may use data received from the user interface 208. For example, the processor 206 may receive text messages from the input devices 212, as provided by a user, which describes the incident 102 at step 406. Of course, as explained above, manual input may be used in combination with the location information, the video characteristics and/or the audio characteristics, to enhance the ability of other wireless communication devices to identify the subject matter of the incident 102. The manual input from the user interface 208 relating to the incident 102 is provided to other wireless communication devices via transceiver 202 or 204.

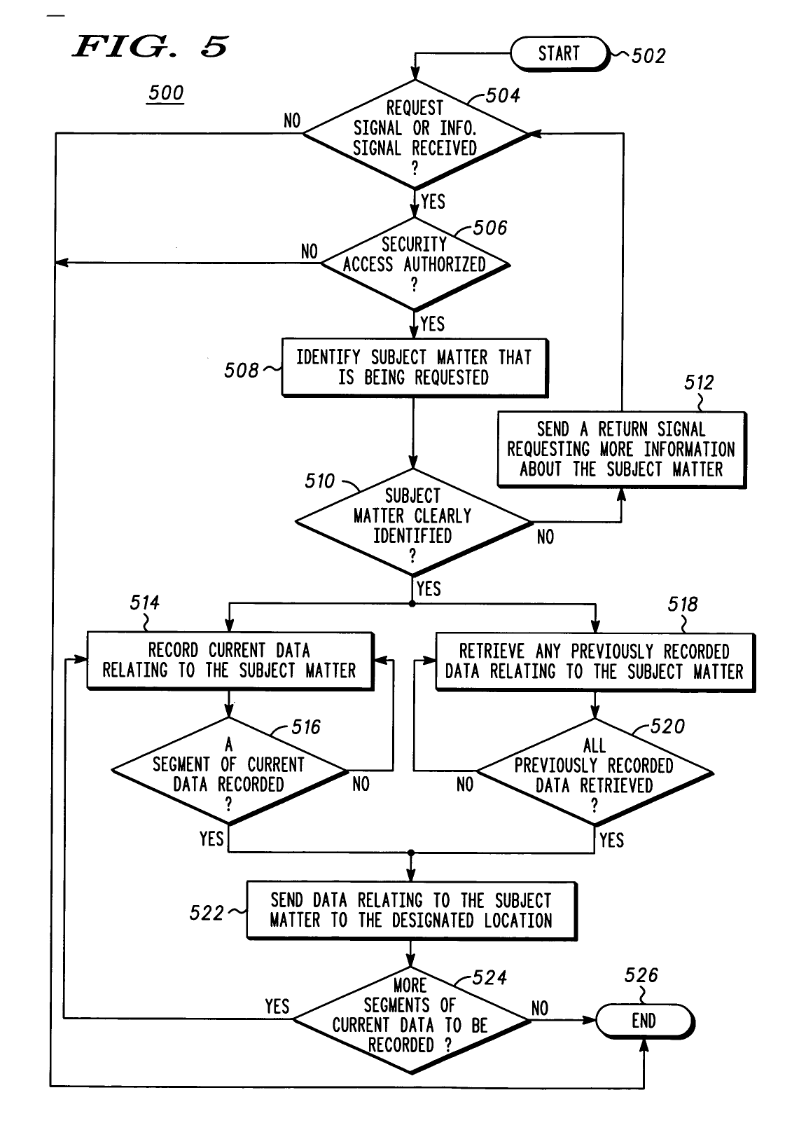

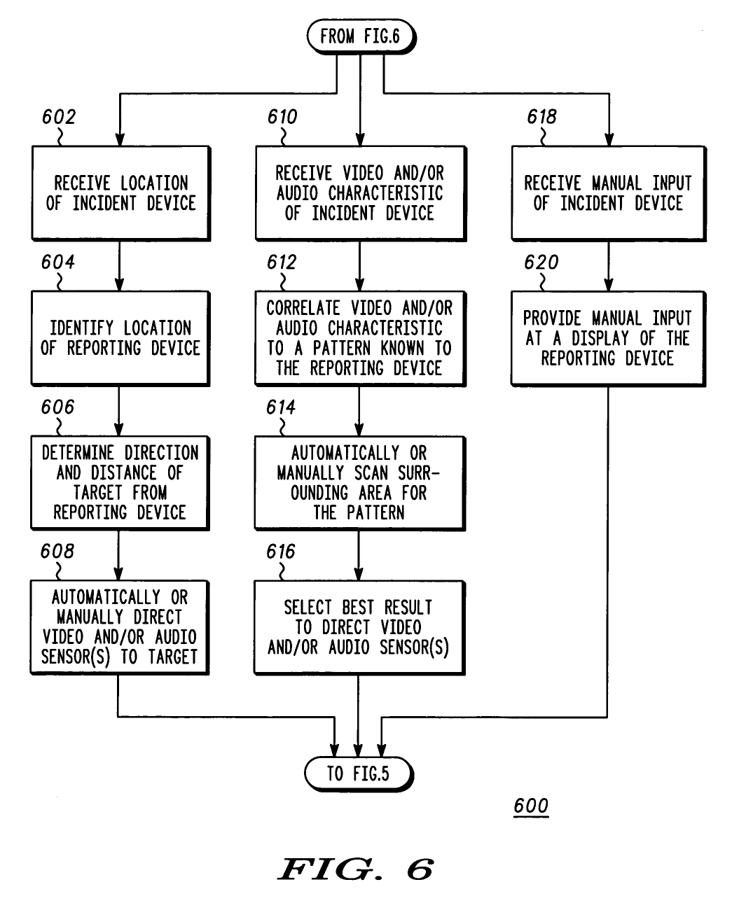

Referring to FIG. 5, there is provided a flow diagram of a responsive reporting procedure 500 of the second reporting devices, such as devices 112, 116, 120 & 124. The responsive reporting procedure 500 shown in FIG. 5 is an exemplary operation that may be executed by the processor 206, stored in the memory portion 216, and provide interaction for the other internal components of each second reporting devices 112, 116, 120, 124. Starting at step 502, the responsive reporting procedure 500 of the second reporting devices 112, 116, 120, 124 determines whether a request signal has been received from an first reporting device, such as the first reporting device 104, at step 504. In various embodiments, as describe above, the request signal may include other information or commands to enhance the operation or prioritization method of the system 100. If a request signal has not been received, then the responsive reporting procedure 500 terminates at step 526. On the other hand, if the request signal is received, then the processor 206 will determine whether security access authorization, for example, by utilizing certified public key methods, will be given to the first reporting device 104 at step 506. If the processor 206 grants security access authorization to the first reporting device 104, then the processor proceeds to identify the subject matter of the incident 102 at step 508, which is describe in more detail in reference to FIG. 6 below.

If the processor 206 is not able to clearly identify the subject matter of the incident 102 at step 508 & 510, then the processor may request more information from the first reporting device 104 at step 512. In particular, a return signal requesting more information about the subject matter of the incident 102 is sent to the first reporting device 104 via transceiver 202 or 204. If the first reporting device 104 does not respond with more information, the responsive reporting procedure 500 terminates at step 526. Otherwise, if more information is received, then the processor 206 tries again to identify the subject matter of the incident 102 at step 508 & 510. Requests for more information continue until the processor 206 fails to receive more information from the first reporting device 104 or identifies the subject matter of the incident 102. Regarding step 506, security access may either be required only once when the request signal is initially received or else it may be required every time when a signal is received.

Once the subject matter of the incident 102 is identified by the second reporting devices 112, 116, 120, 124, the processor 206 records current data relating to the subject matter and/or retrieves any previously recorded data relating to the subject matter. The current data and the previously recorded data may be obtained serially or, as shown in FIG. 5, obtained in parallel. The processor 206 may obtain current data from the sensors 222 at step 514. The processor 206 continues to record the current data until a predetermined time period or file size has been recorded, as determined by step 516. Similarly, the processor 206 may obtain previously recorded data from the memory portion 216 at step 518. The processor 206 continues to retrieve the previously recorded data until a predetermined time period or file size has been retrieved, as determined by step 520.

After the current data is recorded, the previously recorded data is retrieved or both, the processor 206 may send the data to a designated location at step 522. The designated location may be the first reporting device 104 or the local server 130 that forwards the data to the incident reporting center 128 or the designated location may be the incident reporting center itself. If more data relating to the incident 102 is available from the sensors 222 or is required by the incident reporting center 128, then the processor 206 may continue to record more current data at step 524 and repeat steps 514, 516 and 522. Finally, the responsive reporting procedure 500 terminates at step 526.

Referring to FIG. 6, there is provided possible operational details of request signal or information signal reception at step 504 of FIG. 5. The processor 206 may perform one or more of these steps to identify the subject matter of the incident 102, depending upon the information received. For one embodiment, the processor 206 may receive a location of the first reporting device 104 at step 602. The processor 206 then determines the location of the second reporting devices 112, 116, 120, 124 based on data received from the location sensor 228 at step 604. Next, based on the locations of the first reporting device 104 and the second reporting devices 112, 116, 120, 124, the processor 206 may determine a direction and distance of the incident 102 relative to the second reporting device at step 606. The processor 206 may then instruct the video sensor 224 and/or the audio sensor 226 to be directed towards the calculated direction and distance, or the processor may instruct the user via the output devices 210 to aim the video sensor and/or audio sensor towards the calculated direction and distance at step 608. To further enhance the determination of the incident location, the processor 206 may receive distance and direction data of the incident from the first reporting device 104.

For another embodiment, the processor 206 may use video and/or audio characteristics of the incident 102 received from the first reporting device 104 at step 610. If necessary, the processor 206 may correlate the video and/or audio characteristics to a pattern known to the second reporting devices 112, 116, 120, 124 at step 612. Step 612 may be necessary when the first reporting device 104 and the second reporting devices 112, 116, 120, 124 utilize different criteria for categorizing video and/or audio characteristics. The processor 206 may then instruct the video sensor 224 and/or the audio sensor 226 to scan the area surrounding the second reporting devices 112, 116, 120, 124, or the processor may instruct the user via the output devices 210 to scan the area surrounding the second reporting device at step 614. Based on this scanned information, the processor 206 selects the best results to direct the sensors 222 at step 616. Accordingly, the sensors 222 are automatically directed to the best results or manually directed via the user directed to the best results.

For yet another embodiment, the processor 206 may receive and display text messages, originating from the first reporting device 104, at the output devices 210 of the second reporting devices 112, 116, 120, 124 to the user that describes the incident 102 at steps 618 and 620. Of course, as explained about, manual input may be used in combination with the location information, the video characteristics and/or the audio characteristics, to enhance the ability of the second reporting devices 112, 116, 120, 124 to identify the subject matter of the incident 102.

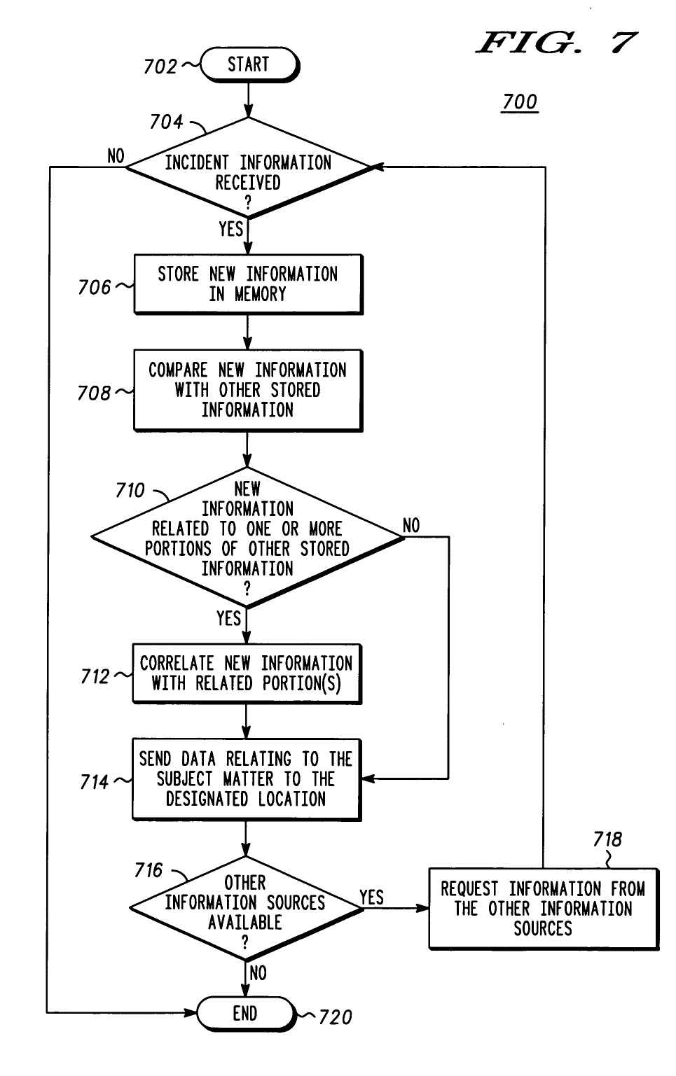

Referring to FIG. 7, there is provided a flow diagram representing a data gathering procedure 700 of the local server 130. Starting at step 702, the processor 206 determines whether incident information is received via a transceiver 202 or 204 at step 704. If incident information is not received, then the data gathering procedure 700 terminates at step 720. On the other hand, if incident information is received, then the newly received information is stored in the memory portion 216 of the local server 130 at step 706. Thereafter, data relating to the subject matter of the incident 102, including the newly received information, is sent to a designated location at step 714. Preferably, the designated location is the incident reporting center 128. Thereafter, the data gathering procedure terminates at step 720.

The local server 130 may optionally perform additional procedures to enhance the operation of the system 100. In one embodiment, the processor 206 of the local server 130 compares the newly received information with previously received information at step 708. The newly received information is received from the transceiver 202 or 204, whereas the previously received information is retrieved from the memory portion 216. Next, the processor 206 determines whether the newly received information is related to one or more portions of the previously received information, i.e., relating to similar incidents, at step 710. If the newly received information is related to all or a portion of the previously received information, then the processor 206 correlates the new information with the related portion or portions at step 712. For example, the new information and the related portion or portions may be tagged with the same identification code or associated with each other by an index or table stored in the memory portion 216.

In another embodiment, the processor 206 of the local server 130 determines whether other information sources are available at step 716. The processor 206 may receive this information from the first reporting device 104, since the first reporting device has already scanned for such devices. In the alternative, the processor 206 may receive this information from the second reporting devices 112, 116, 120, 124 or scan for other information sources via one or more transceivers 202, 204 of the local server 130. If other information sources are available, then the processor 206 requests information from the other information sources at step 718 and returns to step 704 to await a response to its request.

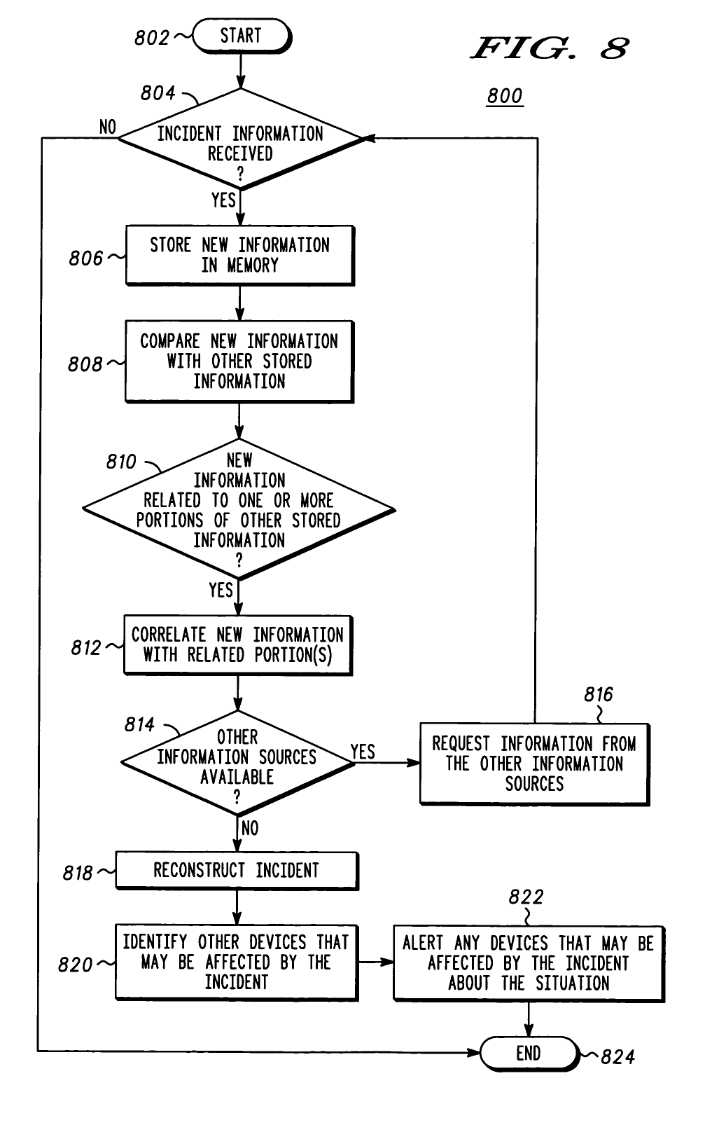

Referring to FIG. 8, there is provided a flow diagram representing an incident processing procedure 800 of a central authority, such as the incident reporting center 128. Starting at step 802, the processor 206 of the incident reporting center 128 determines whether incident information is received via a transceiver 202 or 204 at step 804. If incident information is not received, then the incident processing procedure 800 terminates at step 824. On the other hand, if incident information is received, then the newly received information is stored in the memory portion 216 of the incident reporting center at step 806. Thereafter, data relating to the subject matter of the incident 102, including the newly received information, is analyzed to reconstruct the incident 102 at step 818.

By reconstructing the incident 102, the processor 206 may draw various conclusions about the incident, such as what caused the incident and what parties were involved. Next, the processor 206 may identify other devices that may be affected by the incident at step 820. Preferably, the possibly affected devices are identified for the incident reporting center 128 by the first reporting device 104, the second reporting devices 112, 116, 120, 124 and/or the local server 130. Upon identifying the possibly affected devices, the processor 206 sends an alert about the situation to any device that may be affected by the incident at step 822. The incident reporting center 128 may send the alert via the wireless communication devices 104, 112, 116, 120, 124, via the local server 130, and/or directly from the incident reporting center. Thereafter, the incident processing procedure 800 terminates at step 824.

If the incident might affect others in the immediate area or in another area, the incident reporting center 128 may determine the devices in that vicinity via the network operator or via a short-range communication media and alert one or more devices of the impending situation. At a minimum, this could be a text message such as “suspicious activity on Red Line Subway Train Northbound vicinity of Belmont Ave.” For example, if the situation occurred on Chicago's Red Line near Belmont Avenue, the warning might be sent to subscribers located near the Red Line tracks and Belmont Avenue, as well as subscribers on Red Line trains and platforms. If there is reason to believe that an individual has perpetrated an offense, the alert may include a composite visual image of the person or persons. The composite image would be the result of computer reconstruction as described above at step 818.

Similar to the local server 130, the incident reporting center 128 may optionally perform additional procedures to enhance the operation of the system 100. In one embodiment, the processor 206 of the incident reporting center 128 compares the newly received information with previously received information at step 808. Next, the processor 206 determines whether the newly received information is related to one or more portions of the previously received information, i.e., relating to similar incidents, at step 810. If the newly received information is related to all or a portion of the previously received information, then the processor 206 correlates the new information with the related portion or portions at step 812.

In another embodiment, once the incident reporting center 128 receives an incident report message and the identifications of devices near the incident 102, the incident reporting center may request the nearby devices to upload the contents of their data collections, preferably starting with the most nearby devices. The processor 206 of the incident reporting center 128 may determine whether other information sources are available at step 814. The processor 206 may receive this information from the first reporting device 104, the second reporting devices 112, 116, 120, 124 or the local server 130. If other information sources are available, then the processor 206 requests information from the other information sources at step 816 and returns to step 804 to await a response to its request. Once the incident reporting center 128 determines the availability of information sources, a request is sent to members of the ad-hoc proximity network. In the event that many devices are or were close to the incident 102, the request will address nearby devices in the order of decreasing distance, based on signal strength reports. An information-reduction algorithm might also be applied, such that a limited number of video, audio or multimedia frames is requested of each device during the initial phase of the data-gathering process.

The additional contributions from other devices, in addition to the first reporting device 104, are helpful for the reconstruction and analysis of the incident 102. However, in some situations, such as inside a packed subway train or at a crowded concert, the number of nearby devices could be quite large, due to the margin of error in location technology. In a high concentration environment, reliance on many devices may present an overwhelming amount of data to the dispatcher, and much of the reported data might be uncorrelated to the incident. Accordingly, it may be helpful to provide filtering schemes at the point of data gathering, whether it is the first reporting device 104, the local server 130 or the incident reporting center 128.

When a sufficient number of images and other media have been received from the incident scene, computer-aided techniques may be applied to determine the specific location, distinguished from background artifacts, as well as to identify individuals who appear on the image frames. In some instances, the individuals may be matched to known offenders via large database matching techniques. For example, cross-matching of individuals from frame to frame, particularly from a single video sensor, and between nearby devices may be utilized in order to reconstruct the dynamics of the incident.

An first reporting device 104 may be damaged as a result of the incident 102. In such a case, the ad-hoc network may be formed by using another nearby device that responds to the short-range communication of the first reporting device 104. For example, the first reporting device 104 determines that it cannot successfully communicate to the incident reporting center 128, by detecting that its transceiver is, or transceivers are, defective. Then, the first reporting device 104 requests that the nearest device, such as one having the highest short-range signal strength, assume the responsibility of reporting the incident. In order to ensure that devices may be trusted, identifications and other information could be protected by public-key-based certificates issued by trusted Certification Authorities (“CAs”) using methods such as developed by RSA Security Inc.

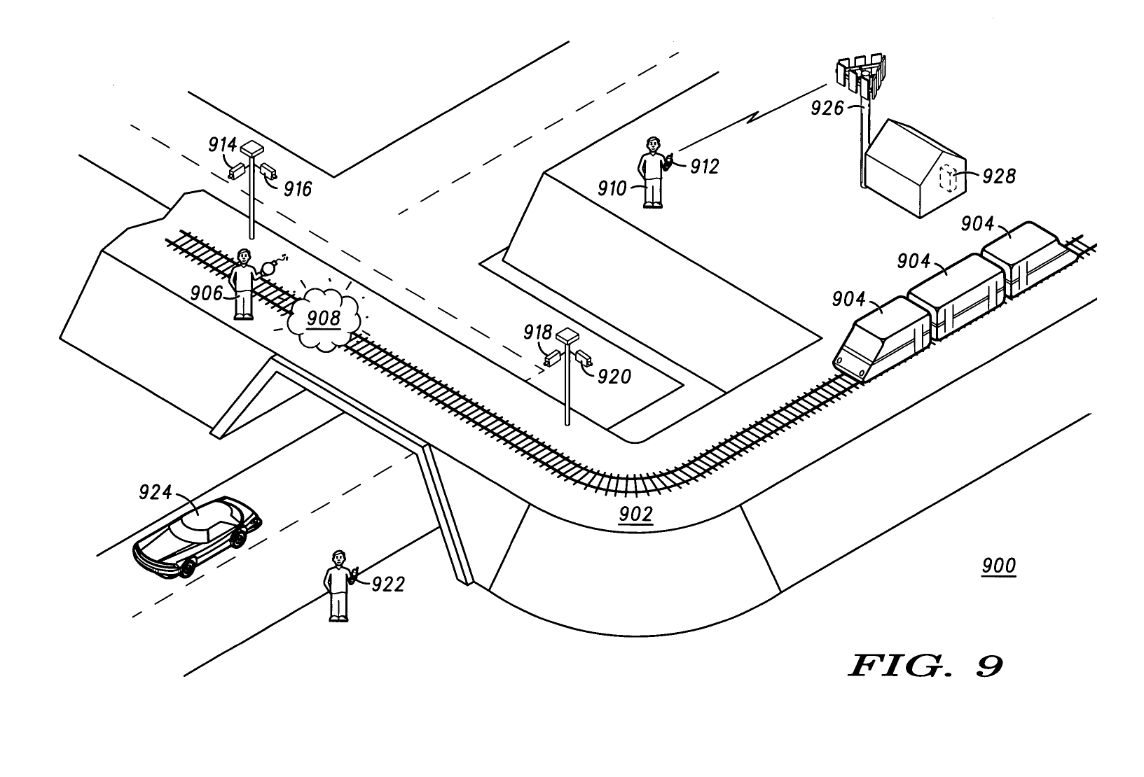

Referring to FIG. 9, there is provided a perspective view of an exemplary incident that may utilize the present invention. FIG. 9 shows a platform 902 for loading and unloading of passengers for commuter railcars 904. For this example, a perpetrator 906 is committing or has committed a crime at the platform and a criminal incident 908 has occurred. Near the location of the incident 908, a witness 910 with a wireless communication device, i.e., first reporting device 912, collects video and audio data relating to the incident using the first reporting device. The witness 910 also scans the area and determines that there are six other wireless communication devices 914, 916, 918, 920, 922, 924 nearby. At the platform 902, there are four stationary video cameras 914, 916, 918, 920 monitoring activities at the platform. In addition, there is pedestrian carrying a camera phone 922 and a driver of a passing car with a camera phone 924 locate below and away from the platform 902. Unfortunately, the camera phones 922, 924 of the pedestrian and the driver are not within viewing distance of the incident 908.

In view of the above exemplary situation, the first reporting device 912 may record video and audio information relating from the incident 908 and request the four stationary video cameras 914, 916, 918, 920 to record video information relating to the incident. The first reporting device 912 may also request the camera phone 922 of the pedestrian to record video and audio data relating to the incident. The camera phone 922 may not record any video information of the incident, but may record audio information of the incident and may possibly obtain video footage of the perpetrator 906.

Also, in this exemplary situation, there is a cellular base station 926 and a local server 928 located nearby. Thus, each of the wireless communication devices may contact the incident reporting center (not shown in FIG. 9) directly via the cellular network represented by the cellular base station 926, or indirectly via a short-range communication media to the local server 928. It should be noted that, if any particular device is not able to send relevant data to the incident reporting center soon after the occurrence of the incident, the device may store the data in its memory portion until such time when the data may be delivered to the incident reporting center.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method for a wireless communication device to provide information about an incident, the method comprising:
detecting an activation input associated with an incident event;
scanning for at least one remote device;
coordinating collection of data with the at least one remote device;
recording data relating to the subject matter of the incident event; and
transmitting the recorded data to a designated location.

2. The method of claim 1, wherein coordinating collection of data with the at least one remote device includes informing the at least one remote device about the designated location.

3. The method of claim 1, further comprising receiving authorization to utilize data obtained by the at least one remote device.

4. The method of claim 1, further comprising identifying subject matter of the incident event based on the activation input.

5. The method of claim 1, further comprising:
retrieving previously recorded data relating to the subject matter of the incident event; and
transmitting the previously recorded data to the designated location.

6. The method of claim 1, wherein:
scanning for the at least one remote device including scanning via a wireless local area network; and
transmitting the recorded data to a designated location includes transmitting via a cellular communication system.

7. A method for a wireless communication device to provide information about an incident, the method comprising:
detecting, from a remote device, a request signal associated with an incident event;
receiving information from the remote device about a designated location;
recording data relating to the subject matter of the incident event; and
transmitting the recorded data to the designated location.

8. The method of claim 7, further comprising identifying subject matter of the incident event based on at least one of: location of the remote device, video characteristics received from the remote device, audio characteristics received from the remote device, and manual input received from a user interface of the remote device.

9. The method of claim 7, further comprising providing authorization to the remote device to utilize the recorded data.

10. The method of claim 7, further comprising:
identifying subject matter of the incident event based on the request signal; and
requesting more information from the remote device if the subject matter cannot be clearly identified.

11. The method of claim 7, further comprising:
retrieving previously recorded data relating to the subject matter of the incident event; and
transmitting the previously recorded data to the designated location.

12. The method of claim 7, wherein transmitting the recorded data to a designated location includes transmitting via a wireless communication system.

13. A method of a central authority for receiving information about an incident from at least one remote device, the method comprising:
receiving, from a remote device, incident information associated with an incident event;
comparing the incident information to previously received information to identify at least one portion of the previously received information that relates to the incident information, the at least one portion including information received from a device other than the remote device; and
correlate the incident information with the at least one portion of the previously received information that relates to the incident information.

14. The method of claim 13, further comprising:
determine whether other information sources are available; and
request information from the other information sources that are available.

15. The method of claim 13, further comprising reconstructing the incident event based on the incident information and the at least one portion of the previously received information that relates to the incident information.

16. The method of claim 13, further comprising:
identify other devices that may become affected by the incident event; and
alert any devices that may become affected by the incident event.

17. A system for processing information about an incident comprising:
a first wireless communication device including a first short-range transceiver to transmit a request signal and a first media sensor to collect data relating to an incident event in response to a user activation input;
a second wireless communication device including a second short-range transceiver to receive the request signal and a second media sensor to collect data relating to the incident event in response to the request signal; and
a central authority configured to receive the data collected by the first and second wireless communication devices relating to the incident event and performing an action in response to receiving the data.

18. The system of claim 17, further comprising a local server having a third short-range transceiver to receive the request signal and to gather the data collected by the first and second wireless communication devices, the local server configured to forward the gathered data to the central authority.

19. The system of claim 17, wherein the first wireless communication device includes a wireless transceiver to communicate the data collected by the first media sensor to the central authority.

20. The system of claim 17, wherein the second wireless communication device includes a wireless transceiver to communicate the data collected by the second media sensor to the central authority.

21. The system of claim 17, wherein:
the second wireless communication device sends the data collected by the first media sensor to the first wireless communication device via the first and second short-range transceivers; and
the first wireless communication device includes a wireless transceiver to communicate the data collected by the first and second media sensors to the central authority.

22. The system of claim 17, wherein the central authority determines whether other information sources are available and requests information from the other information sources that are available.

23. The system of claim 17, wherein the central authority reconstructs the incident event based on the data collected by at least the first and second media sensors.

24. The system of claim 17, wherein the central authority identifies other devices that may become affected by the incident event and alerts any devices that may become affected by the incident event.
